(19) United States
(12) Patent Application Publication
(10) Pub. No.: US 2019/0331064 A1
(43) Pub. Date: Oct. 31, 2019

(54) EVAPORATED FUEL PROCESSING DEVICE

(71) Applicant: AISAN KOGYO KABUSHIKI KAISHA, Obu-shi (JP)

(72) Inventors: Daisaku Asanuma, Gamagori-shi (JP); Nobuhiro Kato, Tokai-shi (JP)

(21) Appl. No.: 16/089,542

(22) PCT Filed: Mar. 3, 2017
(86) PCT No.: PCT/JP2017/008604

§ 371 Date: Sep. 28, 2018

(30) Foreign Application Priority Data
Mar. 30, 2016 (JP) 2016-06936

(51) Int. Cl. F02M 25/08

(52) U.S. Cl. CPC F02M 25/0854; F02D 41/0045; F02M 25/0809

(57) ABSTRACT

An evaporated fuel processing device may be provided with: a canister configured to adsorb fuel evaporated in a fuel tank; a purge passage connected between the canister and an intake passage of an engine; a pump provided on the purge passage; a concentration sensor configured to detect a concentration of purge gas; a branch passage connected to the purge passage; and a switching device configured to switch between a state in which the purge gas passes through the purge passage between both ends of the branch passage and a state in which the purge gas does not pass through the purge passage between the both ends of the branch passage. The concentration sensor is provided on the branch passage.

### TECHNICAL FIELD

The description herein discloses a technique related to an evaporated fuel processing device. Especially, an evaporated fuel processing device configured to process evaporated fuel generated in a fuel tank by purging the same to an intake passage of an engine is disclosed.

### BACKGROUND ART

JP H6-101534 describes an evaporated fuel processing device. In this Patent Document I, a sensor configured to detect a fluid density of air introduced to a canister and a sensor configured to detect a fluid density of a purge gas sent to an engine from the canister are provided, and a concentration of the purge gas is calculated based on a ratio or a difference of the fluid densities thereof.

### SUMMARY OF INVENTION

### Technical Problem

When a sensor is provided on a passage (purge passage) from a canister to an engine (intake pipe for supplying air to the engine), this sensor becomes a resistance (airflow resistance) and there may be a case where a supply quantity of purge gas is thereby restricted. To sufficiently process evaporated fuel adsorbed in the canister, it is necessary to suppress the resistance in the purge passage. The description herein provides a technique capable of detecting a concentration of a purge gas while suppressing an increase in a resistance in a purge passage.

### Solution to Problem

An evaporated fuel processing device disclosed herein may comprise a canister, a purge passage, a pump, a concentration sensor, a switching device, and a control valve. The canister may be configured to adsorb fuel evaporated in a fuel tank. The purge passage may be connected between an intake passage of an engine and the canister. A purge gas sent from the canister to the engine may pass through the purge passage. The pump may be provided on the purge passage. A branch passage may have both ends thereof connected to the purge passage, and may be provided with the concentration sensor. The switching device may be configured to switch between a purge passage passing state and a purge passage non-passing state, wherein the purge passage passing state is a state in which the purge gas flows to the intake passage by passing through the purge passage between the both ends of the branch passage, and the purge passage non-passing state is a state in which the purge gas flows to the intake passage without passing through the purge passage between the both ends of the branch passage. The control valve may be provided on the purge passage between the intake passage and the pump, and may be configured to switch between a communication state and a cutoff state, wherein the communication state is a state in which the purge passage and the intake passage communicate with each other, and the cutoff state is a state in which communication between the purge passage and the intake passage is cut off.

The evaporated fuel processing device as above can introduce the purge gas to an intake pipe while detecting the concentration of the purge gas by setting the control valve to the communication state when the switching device is in the purge passage non-passing state. Further, by setting the control valve to the communication state when the switching device is in the purge passage passing state, the evaporated fuel processing device can introduce the purge gas to the intake pipe without allowing it to pass through the concentration sensor. That is, the purge gas does not pass through the concentration sensor when the concentration of the purge gas does not need to be detected, airflow resistance of the purge gas can thereby be suppressed.

### BRIEF DESCRIPTION OF DRAWINGS

FIG. 1 shows a fuel supply system of a vehicle using an evaporated fuel processing device of a first embodiment;

FIG. 2 shows a variant of the evaporated fuel processing device of the first embodiment;

FIG. 3 shows a fuel supply system of a vehicle using an evaporated fuel processing device of a second embodiment;

FIG. 4 shows a variant of the evaporated fuel processing device of the second embodiment;

FIG. 5 shows an example of a Concentration sensor;

FIG. 6 shows an example of the concentration sensor;

FIG. 7 shows an example of the concentration sensor;

FIG. 8 shows an example of the concentration sensor;

FIG. 9 shows an evaporated fuel supply system;

FIG. 10 shows a flowchart of a method of detecting a concentration and a flow rate of a purge gas;

FIG. 11 shows a flowchart of a method of supplying the purge gas using the evaporated fuel processing device of the first embodiment;

FIG. 12 shows a timing chart of the method of supplying the purge gas using the evaporated fuel processing device of the first embodiment;

FIG. 13 shows a flowchart of a method of supplying the purge gas using the evaporated fuel processing device of the second embodiment;

FIG. 14 shows a timing chart of the method of supplying the purge gas using the evaporated fuel processing device of the second embodiment;

FIG. 15 shows a flowchart of a method of adjusting a purge gas supply quantity;

FIG. 16 shows a flowchart of a method of adjusting the purge gas supply quantity;

FIG. 17 shows a flowchart of a method of adjusting the purge gas supply quantity;

FIG. 18 shows a flowchart of the method of adjusting the purge gas supply quantity;

FIG. 19 shows a flowchart of the method of adjusting the purge gas supply quantity;

FIG. 20 shows a timing chart of the process of adjusting the purge gas supply quantity; and

FIG. 21 shows a timing chart of the process of adjusting the purge gas supply quantity.

### DETAILED DESCRIPTION OF EMBODIMENTS

Primary features of embodiments described below will be listed. It should be noted that the respective technical elements described below are independent of one another, and are useful solely or in combinations.

(Feature 1Airflow resistance of a purge passage may be smaller than airflow resistance of a branch passage. Even in a case where a purge gas can pass through both the purge passage and the branch passage, the purge gas passes through the purge passage. That is, the purge gas can pass through a passage (the purge passage) with less airflow resistance when a concentration of the purge gas does not need to be detected. A switching device may cut off flow of the purge gas to the branch passage when it is in a purge passage passing state in which the purge gas passes through the purge passage between both ends of the branch passage and flows to an intake passage. The purge gas always passes through the purge passage when the concentration of the purge gas does not need to be detected.

(Feature 2) An evaporated processing supply device may include a second switching device provided on the purge passage, and the second switching device is configured to switch between a first state in which the purge passage communicates with the canister and a second state in which the purge passage communicates with open air. The second switching device switches between the first state in which the purge passage on a downstream side than the second switching device is connected to the canister and the second state in which the purge passage on the downstream side than the second switching device is connected to open air. Due to this, the open air can be introduced into the purge passage. A flow rate characteristic of a pump can be known by driving the pump under a predetermined condition (at a predetermined rotary speed) and measuring differences in pressure upon when the air passes through a concentration sensor and upon when the purge gas passes therethrough.

(Feature 3) The evaporated fuel processing device may include a controller configured to control the pump, the switching device, and a control valve. By controlling driving of the pump, switching of the switching device, and the control valve, the concentration of the purge gas can be detected at various timings.

(Feature 4) After a startup operation of a vehicle is performed, the controller may be configured to set the switching device to a purge passage non-passing state, set the control valve to a communication state, and perform control of scavenging the branch passage and detecting the concentration of the purge gas. Here, “scavenging the purge passage” means to discharge the purge gas stagnating in the purge passage from the purge passage to the intake passage prior to the startup operation being performed. Upon when the startup operation of the vehicle is performed, the purge gas from when the vehicle previously stopped may still be stagnating. An accurate current concentration of the purge gas cannot be detected by a measurement of the gas concentration performed under such a state. By scavenging a passage (the branch passage) around the concentration sensor prior to the measurement of the purge gas concentration, the accurate concentration of the purge gas can be detected. The scavenging of the branch passage may be performed by driving the pump, or may be performed by suction force of the intake pipe without driving the pump.

(Feature 5) When the detecting of the concentration of the purge gas has been performed after the startup operation of the vehicle, and purging based on the detected concentration has been performed and stopped, the controller may be configured to set the switching device to the purge passage non-passing state, set the control valve to the communication state, and perform control of detecting the concentration of the purge gas. That is, after the purging of second and subsequent times has been performed, the concentration of the purge gas may be detected after completion of this purging. Due to this, an aperture or a duty ratio of the control valve can be controlled based on the detected gas concentration when the purging is performed next time.

(Feature 6) When the detecting of the concentration of the purge gas has been performed after the startup operation of the vehicle, purging based on the detected concentration has been performed and stopped, and the purging is performed again, the controller may be configured to set the switching device to the purge passage non-passing state, set the control valve to the communication state, and perform control of detecting the concentration of the purge gas. That is, after the purging of the second and subsequent times has been performed, the concentration of the purge gas may be detected when the next purging is started. In this case as well, the aperture or the duty ratio of the control valve may be controlled based on the detected gas concentration when the purging is performed next time.

(Feature 7) The controller may be configured to perform control of driving the pump when the switching device is in the purge passage non-passing state. The purge gas can be supplied surely to the branch passage where the concentration sensor is provided.

### Embodiments

### First Embodiment

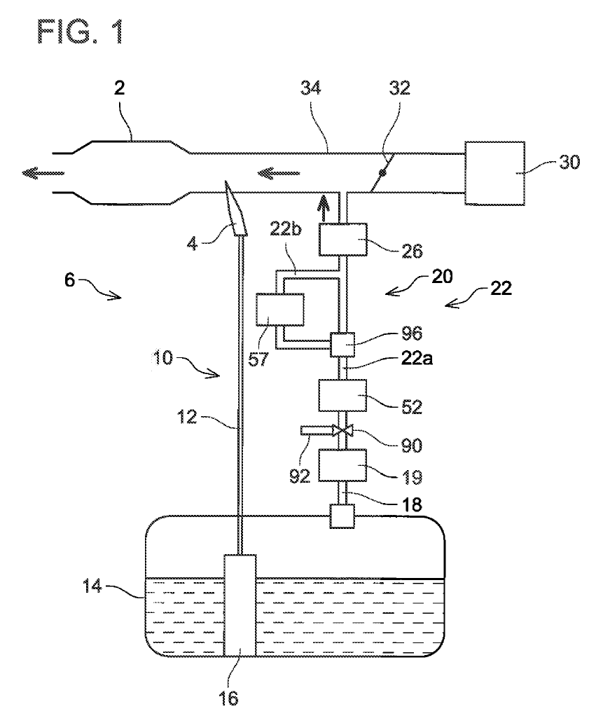

A fuel supply system 6 provided with an evaporated fuel processing device 20 will be described with reference to FIG. 1. The fuel supply system 6 is provided with a main supply passage 10 for supplying fuel stored in a fuel tank 14 to an engine 2 and a purge supply passage 22 for supplying evaporated fuel generated in the fuel tank 14 to the engine 2.

The main supply passage 10 is provided with a fuel pump unit 16, a supply pipe 12, and an injector 4. The fuel pump unit 16 is provided with a fuel pump, a pressure regulator, a control circuit, and the like. The fuel pump unit 16 controls the fuel pump according to a signal provided from an ECU (Engine Control Unit, not shown). The fuel pump boosts the fuel in the fuel tank 14 and discharges the same. The fuel discharged from the fuel pump is pressure-regulated by the pressure regulator and is supplied from the fuel pump unit 16 to the supply pipe 12. The supply pipe 12 is connected to the fuel pump unit 16 and the injector 4. The fuel supplied to the supply pipe 12 passes through the supply pipe 12 and reaches the injector 4. The injector 4 includes a valve (not shown) of which aperture is controlled by the ECU. When the valve of the injector 4 is opened, the fuel in the supply pipe 12 is supplied to an intake pipe 34 connected to the engine 2.

The intake pipe 34 is connected to an air cleaner 30. The air cleaner 30 includes a filter for removing foreign matters in air flowing into the intake pipe 34. The intake pipe 34 is provided with a throttle valve 32. When the throttle valve 32 opens, suction is performed from the air cleaner 30 toward the engine 2. The throttle valve 32 adjusts an aperture of the intake pipe 34 and thereby adjusts a quantity of air flowing into the engine 2. The throttle valve 32 is provided on an upstream side (air cleaner 30 side) than the injector 4.

The purge supply passage 22 includes a purge passage 22a through which a purge gas passes when it flows from a canister 19 to the intake pipe 34, and a branch passage 22b that branches from the purge passage 22a. The purge supply passage 22 is provided with the evaporated fuel processing device 20. The evaporated fuel processing device 20 includes the canister 19, an air/purge gas switching valve 90, the purge passage 22a, a pump 52, a control valve 26, the branch passage 22b, a concentration sensor 57, and a branch passage switching valve 96. The control valve 26 is a solenoid valve controlled by the ECU and is a valve of which switching between a communication state and a cutoff state is controlled on duty basis by the ECU. The control valve 26 adjusts a flow rate of the evaporated fuel (purge gas) by its opened and closed time periods (switching timings between the communication state and the cutoff state) being controlled. Further, a valve capable of adjusting its aperture, such as a stepping motor control valve, may be used instead of the control valve 26.

The fuel tank 14 and the canister 19 are connected by a communication pipe 18. The canister 19, the pump 52, and the control valve 26 are provided on the purge passage 22a. The purge passage 22a is connected to the intake pipe 34 between the injector 4 and the throttle valve 32. The control valve 26 can switch between the communication state in which the purge passage 22a and the intake pipe 34 communicate with each other and the cutoff state in which this communication between the purge passage 22a and the intake pipe 34 is cut off. The pump 52 is provided between the canister 19 and the control valve 26 and pumps the evaporated fuel (purge gas) to the intake pipe 34. Specifically, the pump 52 draws in the purge gas in the canister 19 through the purge passage 22a and pushes the purge gas out into the intake pipe 34 through the purge passage 22a. Inside of the intake pipe 34 is at a negative pressure during when the engine 2 is driving. Due to this, the evaporated fuel adsorbed in the canister 19 can be introduced into the intake pie 34 by a pressure difference between the intake pipe 34 and the canister 19. However, by providing the pump 52 on the purge passage 22a, the evaporated fuel adsorbed in the canister 19 can be supplied to the intake pipe 34 even in a case where the intake pipe 34 is at a pressure that is not sufficient to draw in the purge gas (in a case of a positive pressure while supercharging or in a case of a negative pressure having a small absolute value thereof). Further, by providing the pump 52, a desired quantity of the evaporated fuel can be supplied to the intake pipe 34.

The branch passage 22b is connected to the purge passage 22a. The branch passage 22b has both ends thereof connected to the purge passage 22a on a downstream side than the pump 52 (on an intake pipe 34 side than the pump 52). Of connected portions between the branch passage 22b and the purge passage 22a, the connected portion on an upstream side (the connected portion on a canister 19 side) is connected to the purge passage 22a via the branch passage switching valve 96. The branch passage switching valve 96 can switch between a state in which the purge gas passes through the purge passage 22a between the both ends of the branch passage 22b and a state in which the purge gas does not pass through the purge passage 22a between the both ends of the branch passage 22b. The concentration sensor 57 is provided on the branch passage 22b. The concentration sensor 57 detects a concentration of the purge gas passing through the branch passage 22b.

By providing the branch passage switching valve 96, the purge gas can be introduced to the intake pipe 34 while detecting the concentration of the purge gas by allowing the purge gas to flow in the branch passage 22b. Further, the purge gas can be introduced to the intake pipe 34 without allowing the purge gas to pass through the branch passage 22b. That is, the branch passage switching valve 96 can allow the purge gas to flow only in the purge passage 22a without passing through the branch passage 22b. The state in which the purge gas passes through the purge passage 22a but does not pass through the branch passage 22b can be expressed as a purge passage passing state, and the state in which the purge gas passes through the branch passage 22b but does not pass through the purge passage 22a (the purge passage 22a between the both ends of the branch passage 22b) can be expressed as a purge passage non-passing state. During the purge passage passing state, the purge gas does not pass through the concentration sensor 57, and thus, flow resistance of the purge gas is suppressed from increasing when the concentration of the purge gas does not need to be detected, and the quantity of the purge gas supplied to the intake pipe 34 can be suppressed from being restricted.

Further, the air/purge gas switching valve 90 is provided on the purge passage 22a. The air/purge gas switching valve 90 is arranged on the upstream side than the pump 52. An air introducing pipe 92 is connected to the air/purge gas switching valve 90. The air/purge gas switching valve 90 can switch between a state (a first state) in which the purge passage 22a is connected to the canister 19 and a state (a second state) in which the purge passage 22a is connected to the air introducing pipe 92. The branch passage switching valve 96 is an example of a switching device in the claims, the control valve 26 is an example of a control valve, and the air/purge gas switching valve 90 is an example of a second switching device.

By providing the air/purge gas switching valve 90, in a case where the concentration sensor 57 is a type of concentration sensor that detects a pressure difference between upstream and downstream sides of the sensor, a pressure difference between the upstream and downstream sides of the sensor when air passes through the branch passage 22b can be compared with a pressure difference therebetween when the purge gas passes through the branch passage 22b by switching the air/purge gas switching valve 90. By comparing these pressure differences, a characteristic of the pump 52 (a flow rate of fluid that passes through the pump at a predetermined rotary speed) can be calculated. A flow rate of fluid passing through the pump 52 changes depending on a density (concentration) of the passing fluid, despite an output (rotary speed) of the pump 52 being the same. By providing the air/purge gas switching valve 90 and by comparing the pressure differences in the air and the purge gas passing through a concentration sensor 70, the flow rate characteristic of the pump 52 can be obtained and detection accuracy for the purge gas concentration improves, by which a more accurate quantity of the purge gas can be introduced to the intake pipe 34. The switching valve 90 and the air introducing pipe 92 contribute to improving the detection accuracy for the purge gas concentration, and the concentration of the purge gas can still be detected even when the switching valve 90 and the air introducing pipe 92 are omitted. Further, the control valve 26, the branch passage switching valve 96, and the air/purge gas switching valve 90 are solenoid valves controlled by the ECU.

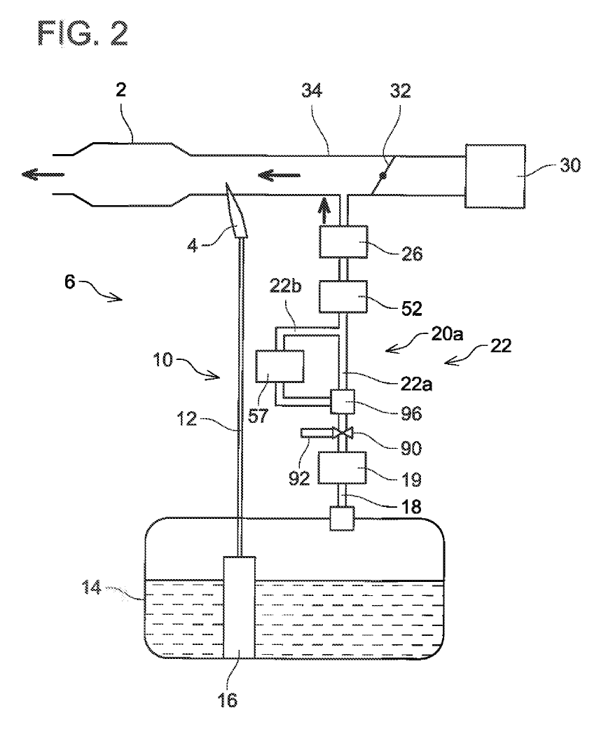

As in an evaporated fuel processing device 20a shown in FIG. 2, the pump 52 may be provided on a downstream side than the branch passage 22b.

### Second Embodiment

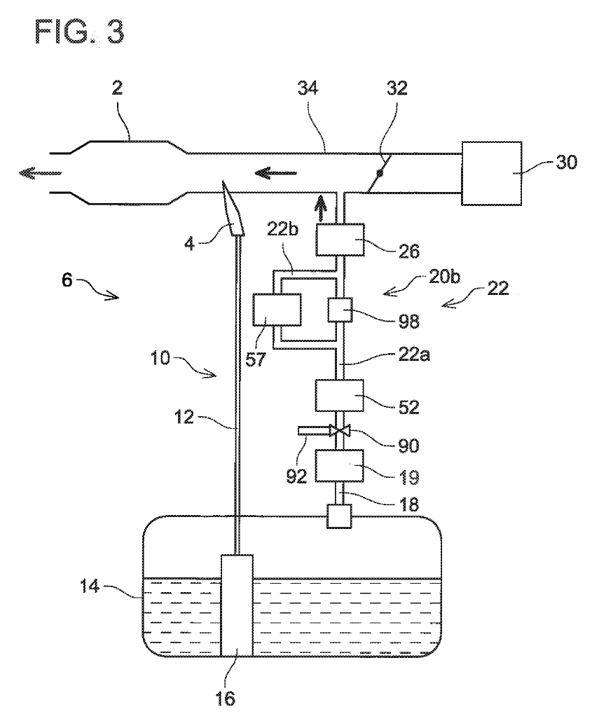

An evaporated fuel processing device 20b will be described with reference to FIG. 3. The evaporated fuel processing device 20b is a variant of the evaporated fuel processing device 20. Specifically, a cutoff valve 98 is provided between upstream and downstream ends of the branch passage 22b. The cutoff valve 98 is an example of the switching device in the claims. For the evaporated fuel processing device 20b, its components that are the same as those of the evaporated fuel processing device 20 will be given the same reference numbers, and description thereof may be omitted.

The cutoff valve 98 switches between a state in which the purge gas does not pass through the purge passage 22a (purge passage non-passing state) and a state in which the purge gas passes through the purge passage 22a (purge passage passing state). That is, when the cutoff valve 98 is open, the purge gas flows to the intake pipe 34 by passing through the purge passage 22a without passing through the branch passage 22b. When the cutoff valve 98 is closed, the purge gas cannot pass through the cutoff valve 98, and thus it inevitably passes through the concentration sensor 57. The evaporated fuel processing device 20b can also supply the purge gas to the intake pipe 34 without allowing it to pass through the concentration sensor 57 by switching the cutoff valve 98 from the cutting off to the communicating state, so the increase in the flow resistance of the purge gas can be suppressed when the concentration of the purge gas does not need to be detected.

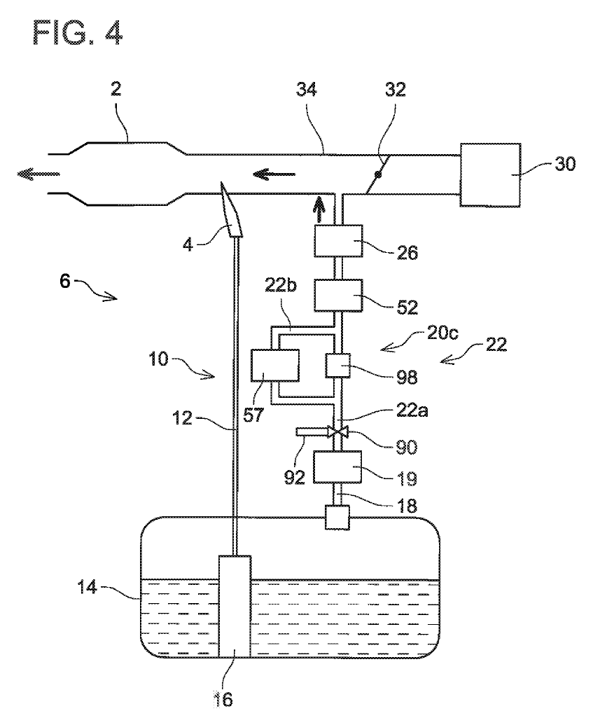

The pump 52 may be provided on the downstream side than the branch passage 22b as in an evaporated fuel processing device 20c shown in FIG. 4.

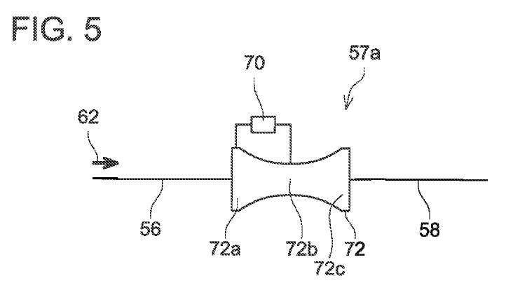

As the concentration sensor 57, various types of sensors may be used. Here, some examples of the concentration sensor 57 that can be used in the evaporated fuel processing device 20 will be described with reference to FIGS. 5 to 8. FIG. 5 shows a concentration sensor 57a provided with a venturi tube 72. One end 72a of the venturi tube 72 is connected to a first branch pipe 56. Another end 72c of the venturi tube 72 is connected to a second branch pipe 58. The differential pressure sensor 70 is connected between the end 72a and a center portion (narrowed portion) 72b of the venturi tube. The concentration sensor 57a detects a pressure difference between the end 72a and the center portion 72b by the differential pressure sensor 70. By detecting the pressure difference between the end 72a and the center portion 72b, the density of the purge gas (purge gas concentration) can be calculated by a Bernoulli's equation,

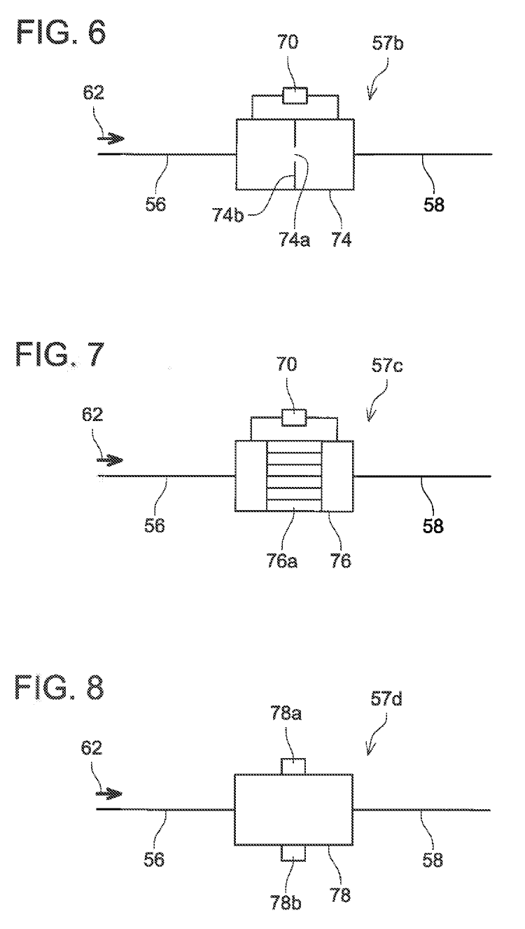

FIG. 6 shows a concentration sensor 57b provided with an orifice tube 74. One end of the orifice tube 74 is connected to the first branch pipe 56, and another end thereof is connected to the second branch pipe 58. An orifice plate 74b including a hole 74a is provided at a center of the orifice tube 74. The differential pressure sensor 70 is connected on upstream and downstream sides relative to the orifice plate 74b. The concentration sensor 57b detects a pressure difference between the upstream and downstream sides of the orifice plate 74b by the differential pressure sensor 70 and calculates the purge gas concentration.

FIG. 7 shows a concentration sensor 57c provided with a capillary viscometer 76. One end of the capillary viscometer 76 is connected to the first branch pipe 56, and another end thereof is connected to the second branch pipe 58. A plurality of capillary tubes 76a is provided inside the capillary viscometer 76. The differential pressure sensor 70 is connected on upstream and downstream sides relative to the capillary tubes 76a. The concentration sensor 57c detects a pressure difference between the upstream and downstream sides of the capillary tubes 76a by the differential pressure sensor 70 and measures a viscosity of the fluid (purge gas) passing through the capillary viscometer 76. By detecting the pressure difference between the upstream and downstream sides of the capillary tubes 76a, the viscosity of the fluid can be calculated by a Hagen-Poiseuille equation. The viscosity of the purge gas has a correlated relationship with the concentration of the purge gas. Due to this, the concentration of the purge gas can be detected by calculating the viscosity of the purge gas.

FIG. 8 shows a concentration sensor 57d provided with a sonic concentration meter 78. The sonic concentration meter 78 has a cylindrical shape. One end of the sonic concentration meter 78 is connected to the first branch pipe 56, and another end thereof is connected to the second branch pipe 58. The sonic concentration meter 78 is provided with a transmitter 78a that transmits a signal into the cylinder and a receiver 78b that receives the signal transmitted from the transmitter 78a. The sonic concentration meter 78 detects a time t which the signal takes to reach the receiver 78b from the transmitter 78a. A sonic speed v in the cylinder is calculated based on the time t and a distance L between the transmitter 78a and the receiver 78b. The sonic speed v in the cylinder has a correlated relationship with the concentration of the purge gas passing through the cylinder. By measuring the sonic speed v in the cylinder, the concentration of the purge gas (molecular weight of the purge gas) can be detected. Specifically, the following formula (1) is known to be satisfied with the sonic speed v, the molecular weight M of the purge gas, a specific heat ratio y, a gas constant R, and an absolute temperature T. By using the following formula (1), the concentration of the purge gas can be detected.

v=(γ×R×T/M)^{0.5} Formula (1)

The four types of the concentration sensors 57 (57a to 57d) have been described above, but other types of concentration sensor may be used in the evaporated fuel processing devices 20a to 20d. What is important is that the branch passage 22b is connected to the purge passage 22a, the concentration sensor 57 is provided on the branch passage 22b, and the switching device (the branch passage switching valve 96, the cutoff valve 98) capable of switching between the state in which the purge gas does not pass through the purge passage 22a (the purge passage non-passing state) and the state in which the purge gas passes through the purge passage 22a (the purge passage passing state) is provided.

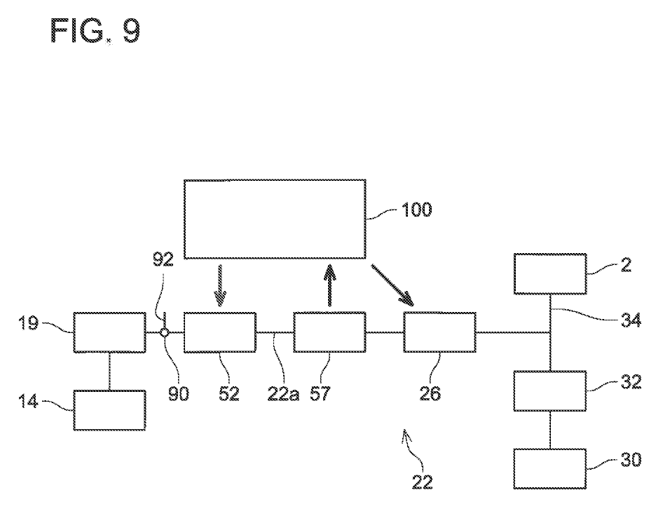

An operation of the purge supply passage 22 upon supplying the purge gas to the intake pipe 34 will be described with reference to FIG. 9. When the engine 2 is activated, the pump 52 starts to drive and the control valve 26 starts its opening and closing operations by control of an ECU 100. The ECU 100 controls the output of the pump 52 and the aperture (or the duty ratio) of the control valve 26 based on the concentration of the purge gas detected by the concentration sensor 57. The ECU 100 also controls the aperture of the throttle valve 32. The evaporated fuel from the fuel tank 14 is adsorbed in the canister 19. When the pump 52 starts to drive, the purge gas that was adsorbed in the canister 19 and the air having passed through the air cleaner 30 are introduced to the engine 2. Hereinbelow, some methods of detecting the concentration of the purge gas will be described.

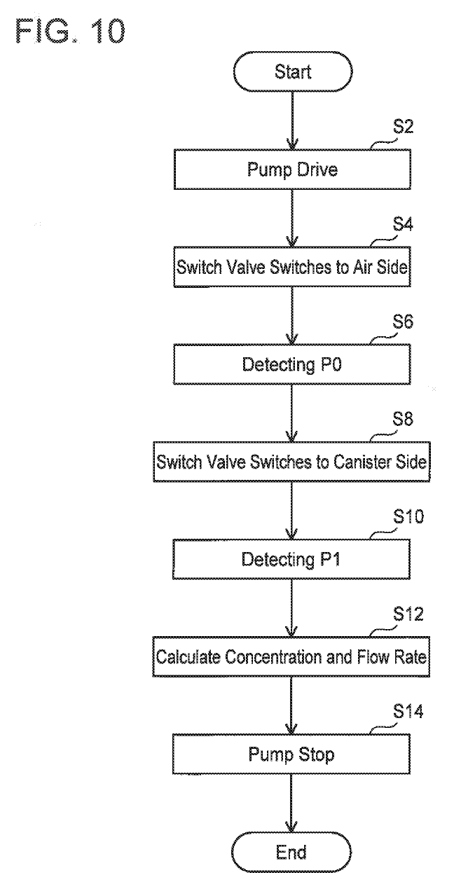

FIG. 10 shows a flowchart explaining a method of detecting the purge gas concentration and a purge gas flow rate. This method is performed for calculating the flow rate characteristic of the pump 52 and detecting the flow rate of the purge gas that passes through the pump 52 when the pump 52 is under the predetermined rotary speed. This method is performed under a state in which the control valve 26 is closed (the purge gas is not introduced to the intake pipe 34). This method may be performed in any of the evaporated fuel processing devices 20, 20a to 20c. However, it is essential to use a concentration sensor of a type which detects a pressure difference between upstream and downstream sides of the sensor, such as the concentration sensors 57a, 57b, and 57c.

Firstly, the pump 52 is driven at the predetermined rotary speed by a control signal outputted from the ECU 100 (step S2). The ECU 100 maintains the control valve 26 in the closed state. Next, the switching valve (the air/purge gas switching valve) 90 switches so as to connect the purge passage 22a and the air introducing pipe 92 by a control signal from the ECU 100 (step S4). Due to this, the open air is introduced to the purge passage 22a, The air introduced to the purge passage 22a passes through the branch passages 56, 58. That is, by driving the pump 52, the air circulates in the purge passage 22a and the branch passage 22b. At this occasion, the concentration sensor 57 detects a pressure difference PO between the upstream and downstream sides of the sensor (step S6). After the detection of the pressure difference PO is completed, the switching valve 90 switches so as to connect the purge passage 22a and the canister 19 by a control signal from the ECU 100 (step S8). Due to this, the purge gas is introduced to the purge passage 22a. The purge gas circulates in the purge passage 22a and the branch passage 22b. The concentration sensor 57 detects a pressure difference P1 between the upstream and downstream sides of the sensor (step S10). After the detection of the pressure difference P1, the concentration and the flow rate of the purge gas are calculated (step S12), and the driving pump 52 is stopped (step S14).

The purge gas is not contained in the open air. That is, a density of the open air is known. Due to this, by detecting the pressure differences P0, P1, the concentration of the purge gas can be detected. For example, by calculating “P1÷P0”, the concentration of the purge gas can be calculated. Further, as aforementioned, the flow rate can be calculated from the Bernoulli's equation. Due to this, the flow rate of the gas (the purge gas, the air) passing through the concentration sensor 57 can be calculated accurately from the gas concentration. Further, by comparing the flow rate of the purge gas with the flow rate of the air upon when the pump 52 is driven at the predetermined rotary speed, the flow rate characteristic of the pump 52 can be obtained. By performing the above method (steps S2 to S14), the flow rate characteristic of the pump 52 can be obtained and the detection accuracy of the purge gas concentration can be improved. Due to this, the steps of introducing the open air to the purge passage 22a and measuring the pressure difference P0 between the upstream and downstream sides of the sensor (steps S4 to 88) may be omitted as needed. Even if steps S4 to S8 are omitted, the concentration of the purge gas can still be detected.

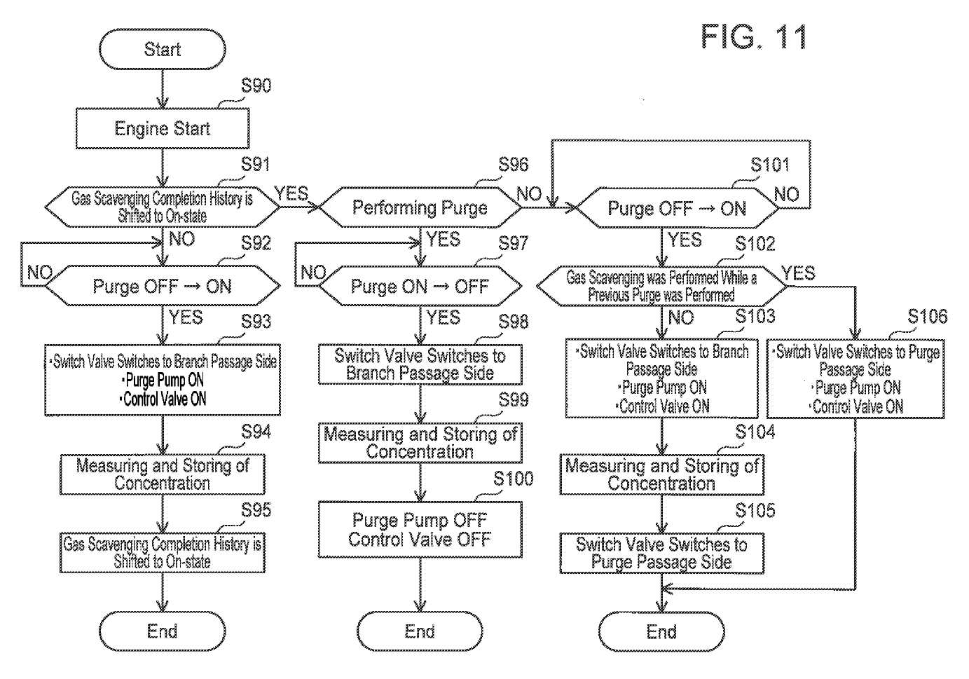

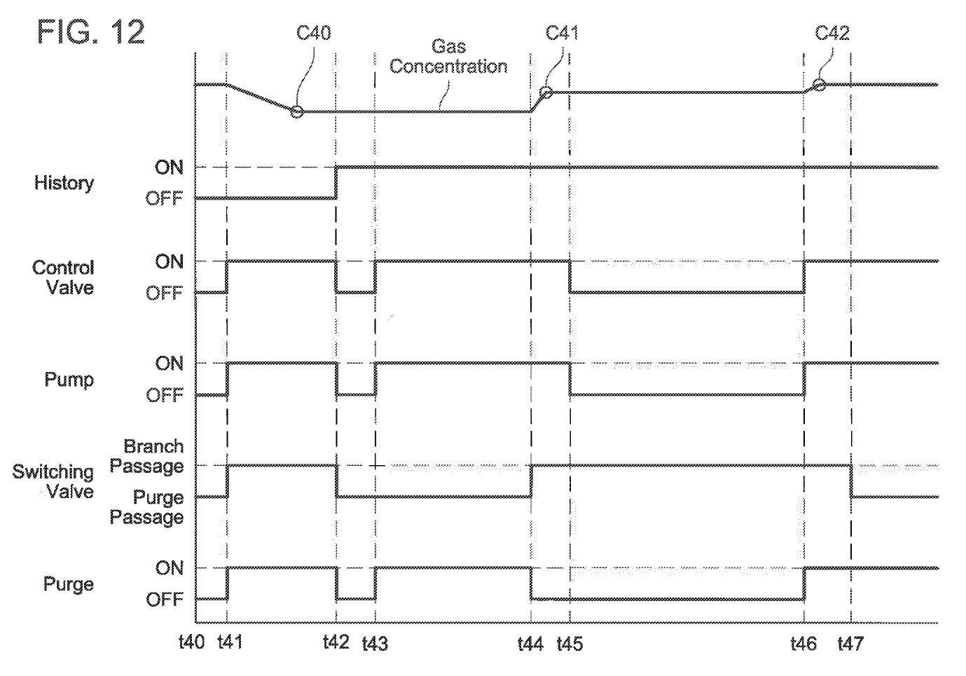

A method of supplying the purge gas using the evaporated fuel processing devices 20, 20a will be described with reference to FIGS. 11 and 12. FIG. 12 is a timing chart showing timings to perform a purge, switching of the branch passage switching valve 96, and on/off states of the pump 52 and the control valve 26. The switching of the branch passage switching valve 96 (switching between the purge passage passing state and the purge passage non-passing state) and on/off of the pump 52 and the control valve 26 are controlled by control signals from the ECU 100.

A timing t40 indicates a timing when the vehicle entered a state in which it is capable of traveling. For example, a time when the engine 2 is activated corresponds to the timing t40. At the timing t40, gas is stagnating in the purge supply passage 22 (especially in the branch passage 22b), and the ECU 100 stores that the gas in the purge supply passage 22 has not been scavenged. At the timing t40, the ECU 100 stores that a gas scavenging completion history is in an OFF state. At the timing t40, the pump 52 and the control valve 26 are off. Further, the switching valve (the branch passage switching valve) 96 is in the state in which the purge gas passes through the purge passage 22a but does not pass through the branch passage 22b. After the engine 2 is activated (step S90), when a purge is started (step S92: YES) under the state in which the gas scavenging completion history is OFF (step S91: NO), the switching valve 96 switches to the purge passage non-passing state (to a branch passage 22b side), and the pump 52 and the control valve 26 are turned on (step S93, timing t41). The concentration of the purge gas is measured during a time from the timing t41 to a timing t42, and this concentration (concentration C40) is stored (step S94). The aforementioned method may be used to measure the concentration of the purge gas. Since the control valve 26 is on between the timings t41 and t42, the gas that was stagnating in the purge supply passage 22 (purge gas that remained upon when a previous purge was completed) can be scavenged from the purge supply passage 22 (that is, discharged to the intake pipe 34). When the gas remaining in the purge passage is scavenged, the evaporated fuel adsorbed in the canister 19 is introduced into the purge passage.

When the scavenging of the remaining gas is completed, the switching valve 96 switches to the purge passage passing state, the pump 52 and the control valve 26 are turned off, and the gas scavenging completion history shifts to an ON state (step S95: timing t42). The gas scavenging completion history is maintained in the ON state while the engine 2 is driving. The scavenging of the remaining gas is completed after the concentration of the purge gas stabilizes (see changes in the gas concentration in FIG. 12). A value of the gas concentration C40 detected between the timings t41 and t42 is used when the ECU 100 sets the next purge to be in an on-state (timing t43).

When it is confirmed that the gas scavenging completion history is in the ON state in step S91 (step S91: YES), steps to be followed thereafter differ depending on whether a purge is being performed or not (step 96). When a purge is started (step S101: YES) under a state in which no purge is being performed (S96: NO), a determination is made on whether or not the remaining gas was scavenged while the previous purge was being performed (step S102). That is, it is determined whether the purge is a purge for a second time (first-time purge is for scavenging). In a case where the purge is the second-time purge (step S102: YES), the switching valve 96 switches to the purge passage passing state, and the pump 52 and the control valve 26 are turned on (step S106: timing t43). During this purge (between timings t43 and t44), the aperture (or the duty ratio) of the control valve 26 and the output of the pump 52 are determined based on the value of the gas concentration C40. Further, during a time between the timings t43 and t44, the purge gas does not flow to the branch passage 22b, so the purge gas does not pass through the concentration sensor 57. A flow resistance of the purge gas can be prevented from increasing.

Next, a case in which it is determined that a purge is being performed in step S96 (step 96: YES) will be described. When the ECU 100 outputs a purge-off signal (step S97: YES), the switching valve 96 switches to the purge passage non-passing state while the pump 52 and the control valve 26 are maintained in the on-states (step S98: timing t44). The purge gas passes through the branch passage 22b and is supplied to the intake pipe 34. A gas concentration C41 of the purge gas is detected while the purge gas is passing through the branch passage 22b, and the gas concentration is stored (step S99: timings t44 to t45). After the detection of the gas concentration C41, the pump 52 and the control valve 26 are turned off (step S100: timing t45). The process from step S97 to step S100 can be said as a process of detecting a purge gas concentration to be used upon when the next purge is performed after the completion of a purge.

Next, a case in which it is determined that the purge is not the second-time purge (the purge is a third-time or subsequent purge) in step S102 will be described (step S102: NO). When the purge is shifted to the on-state (S101: YES), and in the case where this is the third-time or subsequent purge (step S102: NO), the switching valve 96 switches to the purge passage non-passing state, and the pump 52 and the control valve 26 are turned on (step S103: timing t46). The purge gas passes through the branch passage 22b and is supplied to the intake pipe 34. A gas concentration C42 of the purge gas is detected while the purge gas is passing through the branch passage 22b, and the gas concentration is stored (step S104: timings t46 to t47). After the detection of the gas concentration C42, the switching valve 96 switches to the purge passage passing state (step S105: timing t47). The process from step S103 to step S105 can be said as a process of detecting a concentration of the purge gas to be used upon when a purge is performed after the purge has been set to the on-state and before the purge gas supply is actually started.

As aforementioned, step S97 to step S100 are the process of detecting the concentration of the purge gas to be used when the next purge is performed after the present purge is completed, and step S103 to step S105 are the process of detecting the concentration of the purge gas to be used in the purge after this purge has been set to the on-state and before the purge gas supply is actually started. Due to this, in the case where the process of step S97 to step S100 is performed, the process of step S103 to step S105 does not necessarily need to be performed.

When the process of step S97 to step S100 is performed, the purge may be set to the on-state (S101: YES), and in the ease of the third-time or subsequent purge (step S102: NO), the switching valve 96 may be switched to the purge passage passing state, and the pump 52 and the control valve 26 may be turned on. Similarly, when the process of step S103 to step S105 is performed, the pump 52 and the control valve 26 may be turned off when the purge-off signal is outputted (S97: YES).

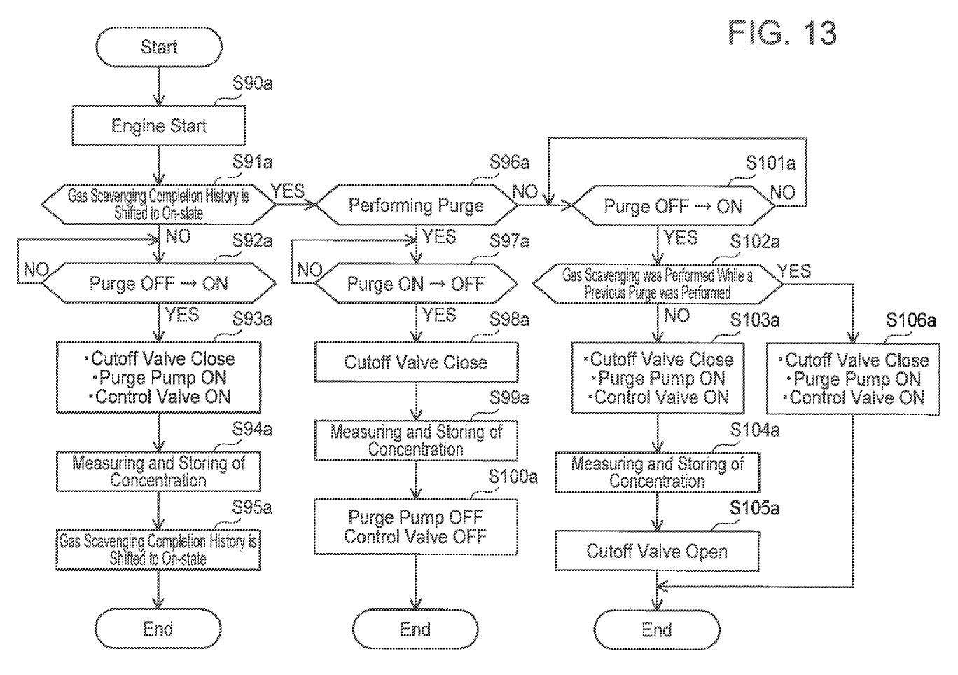

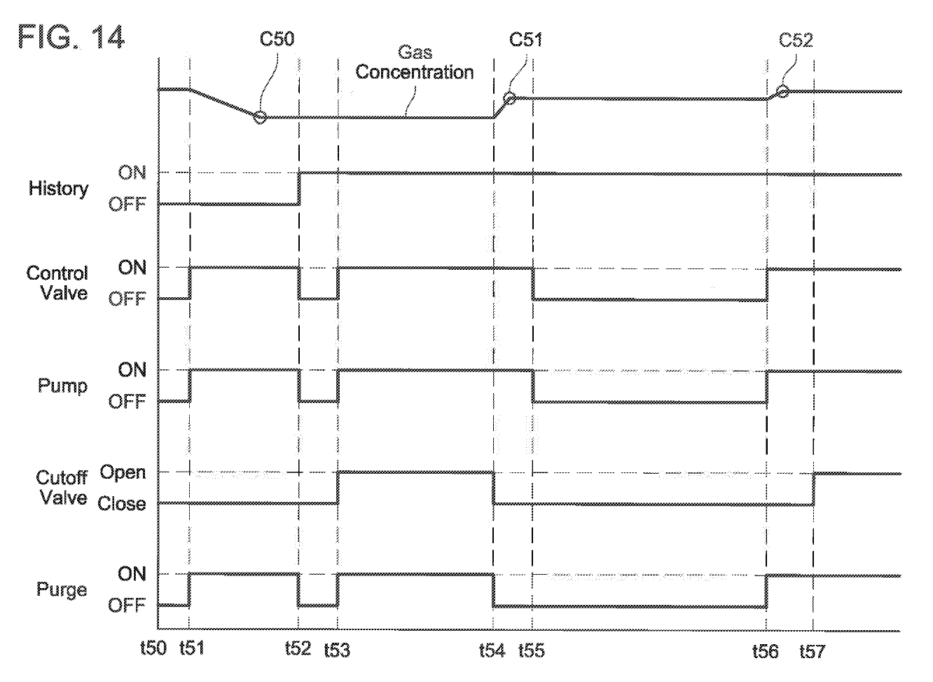

A method of supplying the purge gas using the evaporated fuel processing devices 20b, 20c will be described with reference to FIGS. 13 and 14. FIG. 14 is a timing chart showing timings to perform a purge, switching of the cutoff valve 98, and switching of on/off states of the pump 52 and the control valve 26. The switching of the cutoff valve 98 (switching between the purge passage passing state and the purge passage non-passing state) and on/off of the pump 52 and the control valve 26 are controlled by control signals from the ECU 100.

A timing t50 indicates a timing when the vehicle entered the state in which it is capable of traveling. For example, the time when the engine 2 is activated corresponds to the timing t50. At the timing t50, gas is stagnating in the purge supply passage 22 (especially in the branch passage 22b), and the ECU 100 stores that the gas in the purge supply passage 22 has not been scavenged. At the timing t50, the ECU 100 stores that the gas scavenging completion history is in the OFF state. At the timing t50, the pump 52 and the control valve 26 are off. Further, the cutoff valve 98 is closed and the purge gas passes through the branch passage 22b but does not pass through the purge passage 22a. After the engine 2 is activated (step S90a), when a purge is started (step S92a: YES) under the state in which the gas scavenging completion history is OFF (step S91a: NO), the pump 52 and the control valve 26 are turned on with the cutoff valve 98 closed (in the purge passage non-passing state) (step S93a, timing t51). A concentration of the purge gas is measured during a time between the timing t51 and a timing t52, and this concentration (concentration C50) is stored (step S94a). The aforementioned method may be used to measure the concentration of the purge gas. Since the control valve 26 is on between the timings t51 and t52, the gas that was stagnating in the purge supply passage 22 (the purge gas that remained upon when the previous purge was completed) can be scavenged from the purge supply passage 22.

When the scavenging of the remaining gas is completed, the pump 52 and the control valve 26 are turned off, and the gas scavenging completion history shifts to the ON state (step S95a: timing t52). The gas scavenging completion history is maintained in the ON state while the engine 2 is driving. The scavenging of the remaining gas is completed after the concentration of the purge gas stabilizes (see changes in the gas concentration in FIG. 14). A value of the gas concentration C50 detected between the timings t51 and t52 is used when the ECU 100 sets the next purge in the on-state (timing t53).

When it is confirmed that the gas scavenging completion history is in the ON state in step S91a (step S91a: YES), steps to be followed thereafter differ depending on whether a purge is being performed or not (step S96a). When a purge is started (step S101a: YES) under the state in which no purge is being performed (S96a: NO), a determination is made on whether or not the remaining gas was scavenged while the previous purge was being performed (step S102a). That is, it is determined whether the purge is a second-time purge (the first-time purge is a purge for scavenging), In a case where it is the second-time purge (step S102a: YES), the cutoff valve 98 is opened (switches to the purge passage passing state), and the pump 52 and the control valve 26 are turned on (step S106a: timing t53). During this purge (timings t53 to 54), the aperture (or the duty ratio) of the control valve 26 and the output of the pump 52 are determined based on the value of the gas concentration C50. Between the timings t53 and t54, the purge gas does not flow to the branch passage 22b, so the purge gas does not pass through the concentration sensor 57. The flow resistance of the purge gas can be prevented from increasing.

Next, a case in which it is determined that a purge is being performed in step S96a (step S96a: YES) will be described. When the ECU 100 outputs the purge-off signal (step S97a: YES), the cutoff valve 98 is closed (switches to the purge passage non-passing state) with the pump 52 and the control valve 26 maintained in the on-states (step S98a: timing t54). The purge gas passes through the branch passage 22b and is supplied to the intake pipe 34. A gas concentration CM of the purge gas is detected while the purge gas is passing through the branch passage 22b, and the gas concentration is stored (step S99a: timings t54 to t55), After the detection of the gas concentration C51, the pump 52 and the control valve 26 are turned off (step S100a: timing t55). The process from step S97a to step S 100a can be said as a process of detecting a concentration of the purge gas to be used upon when the next purge is performed, after completion of the purge.

Next, a case in which it is determined that the purge is not the second-time purge (the purge is a third-time or subsequent purge) in step S102a will be described (step S102a: NO). When the purge is set to the on-state (S101a: YES), and in the case where this is the third-time or subsequent purge (step S102a: NO), the cutoff valve 98 is closed, and the pump 52 and the control valve 26 are turned on (step S103a: timing t56). The purge gas passes through the branch passage 22b and is supplied to the intake pipe 34. A gas concentration C52 of the purge gas is detected while the purge gas is passing through the branch passage 22b, and the gas concentration is stored (step S104a: timings t56 to t57). After the detection of the gas concentration C52, the cutoff valve 98 is opened (step S105a: timing t57). The process from step S103a to step S105a can be said as a process of detecting a concentration of the purge gas to be used upon when a purge is performed after the purge has been set to the on-state and before the purge gas supply is actually started.

As aforementioned, steps S97a to S100a are the process of detecting the concentration of the purge gas to be used when the next purge is performed after the present purge is completed, and steps S103a to S105a are the process of detecting the concentration of the purge gas to be used in the purge after this purge has been set to the on-state and before the purge gas supply is actually started. Due to this, in the case where the process of steps S97a to S100a is performed, the process of steps S103a to S105a does not necessarily need to be performed. When the process of steps S97a to S100a is performed, the purge may be set to the on-state (S101a: YES), and in the case of the third-time or subsequent purge (step S102a: NO), the cutoff valve 98 may be opened, and the pump 52 and the control valve 26 may be turned on. Similarly, when the process of steps S103a to S105a is performed, the pump 52 and the control valve 26 may be turned off when the purge-off signal is outputted (S97a: YES).

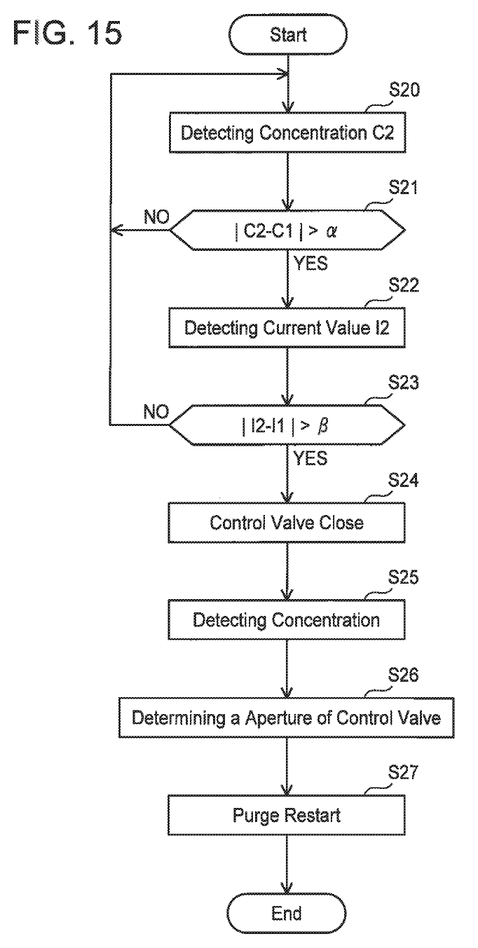

Next, a method of adjusting the supply quantity of the purge gas upon when the concentration of the purge gas changes during a purge will be described with reference to FIG. 15. This method may be performed in any of the evaporated fuel processing devices 20, 20a, 20b, and 20c.

The ECU 100 stores a purge gas concentration C1 detected by the concentration sensor 57 and adjusts a purge quantity to the intake pipe 34 by driving the pump 52 at the predetermined rotary speed based on the concentration C1 and further controlling the control valve 26. The ECU 100 also stores a current value I1 that is supplied upon driving the pump 52 at the predetermined rotary speed. Hereinbelow, the concentration C1 may be termed a stored concentration C1, and the current value I1 may be termed a stored current value I1. A currently measured concentration C2 is detected in step S20, and the stored concentration C1 is compared with the measured concentration C2 in step S21. In a case where a difference between the stored concentration C1 and the measured concentration C2 is smaller than a predetermined value a (step S21: NO), it is determined that a change in the purge gas concentration is within an allowable range, and the purge to the intake pipe 34 is continued based on the stored concentration C1. In a case where the difference between the stored concentration C1 and the measured concentration C2 is greater than the predetermined value a (step S21: YES), the process proceeds to S22, and a measured current value I2 that is currently being supplied to the pump 52 is measured. After this, the measured current value I2 supplied to the pump 52 is compared with the stored current value I1 (step S23). In a case where a difference between the measured current value I2 and the current value I1 is smaller than a predetermined value β (step S23: NO), it is determined that the change in the purge gas concentration is within the allowable range, and the purge to the intake pipe 34 is continued based on the stored concentration C1.

In a case where the difference between the current value I2 and the current value I1 is greater than the predetermined value J3 (step S23: YES), the ECU 100 stops the opening and closing of the control valve 26 and stops the supply of the purge gas to the intake pipe 34 (step S24). After this, a purge gas concentration is measured with the control valve closed (step S25), and the aperture or the duty ratio of the control valve 26 is determined according to the purge gas concentration obtained in step S25 (step S26). After this, the purge is restarted (step S27),

In the above method, in a case where changes in both the measured concentration C2 and the measured current value I2 are large, the purge gas concentration is detected again due to the change in the purge gas concentration being beyond the allowable range. As aforementioned, the flow rate of the pump 52 is dependent on the purge gas concentration. That is, when the purge gas concentration increases, the viscosity of the gas increases and the current value for driving the pump 52 at the predetermined rotary number increases. The change in the current value of the pump 52 exceeding the predetermined value β means that the change in the purge gas concentration is large. In this ease, if the purge is continued as it is, A/F deviates greatly from a control value. By measuring the purge gas concentration again with the control valve 26 closed, the A/F can be suppressed from being deviated,

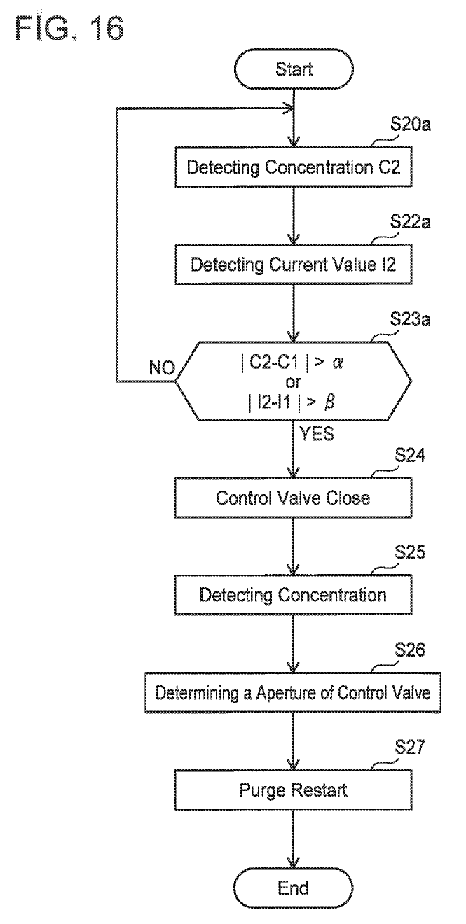

As shown in FIG. 16, in a case where the change in one of the measured concentrations C2 and the measured current value I2 is large, the purge gas concentration may be measured again due to the change in the purge gas concentration being beyond the allowable range. In this case, the measured concentration C2 is detected in step S20a, and the measured current value I2 is detected in step S22a. After this, the stored concentration C1 is compared with the measured concentration C2 and the measured current value I2 is compared with the stored current value I1 (step S23a). In the ease where the difference between the stored concentration C1 and the measured concentration C2 is greater than the predetermined value a or in the case where the difference between the current value I2 and the stored current value I1 is greater than the predetermined value β, the opening and closing of the control valve 26 is stopped (step S24a), the concentration of the purge gas is measured (step S25a), the aperture (duty ratio) of the control valve 26 is determined (step S26a), and the purge is restarted (step S27a). In this case, when the concentration of the purge gas changes, the change can more surely be detected.

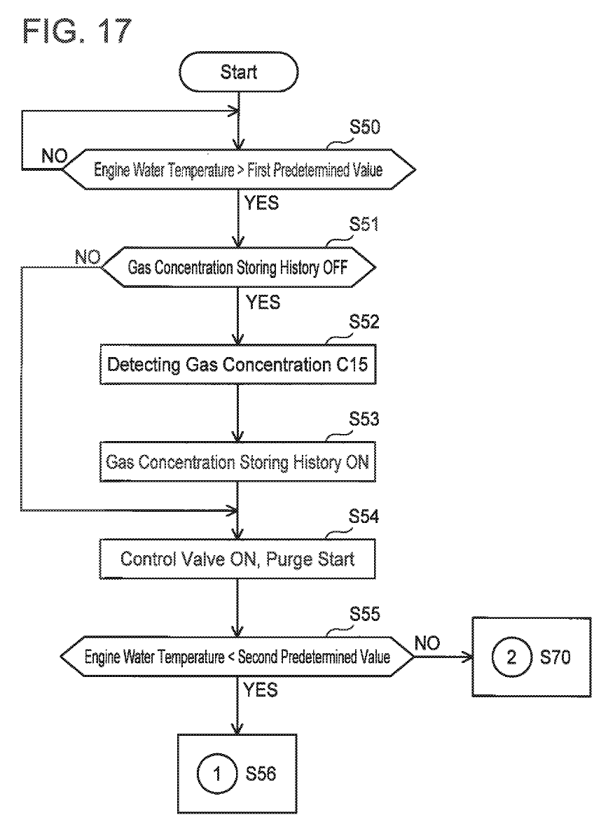

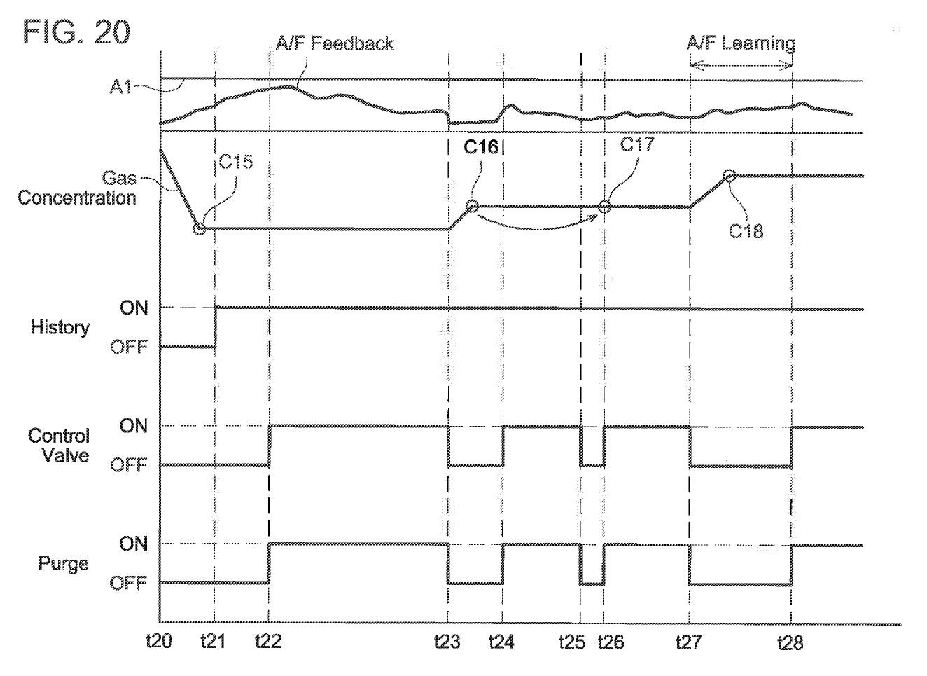

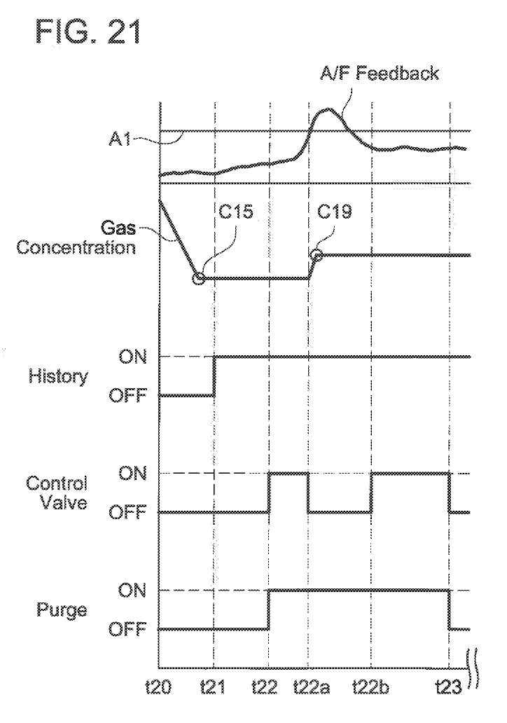

Another method of adjusting the supply quantity of the purge gas upon when the concentration of the purge gas changes during a purge will be described with reference to FIGS. 17 to 21. This method may be performed in any type of the evaporated fuel processing devices 20, 20a, 20b, and 20c. In this method, the purge gas is supplied to the intake pipe 34 while the concentration of the purge gas is corrected based on a temperature change in the engine 2. FIGS. 20 and 21 are timing charts indicating timings to perform a purge and the on/off states of the control valve. The on/off states of the control valve 26 are controlled by a control signal from the ECU 100.

Typically, after the engine has been activated, a temperature of the engine rises. When the temperature of the engine rises, a temperature in the purge passage also rises and the concentration of the purge gas in the purge passage thereby changes. The concentration of the purge gas can be detected accurately by detecting the concentration of the purge gas based on the temperature change of the engine, and the A/F can be suppressed from being deviated. As the engine is driven, an engine water temperature (temperature of cooling water in the engine) rises. In this method, the method of detecting the purge gas concentration is changed depending on whether or not the engine water temperature exceeds a predetermined value.

In step S50 of FIG. 17, it is determined whether or not the engine water temperature exceeded a first predetermined value (e.g., 15° C.). In a case where the engine water temperature does not exceed the first predetermined value (step S50: NO), the engine water temperature is repeatedly measured until the engine water temperature exceeds the first predetermined value. When the engine water temperature has exceeded the first predetermined value (step S50: YES), in a case where a gas concentration history for the purge gas is not stored in the ECU 100 (step S51: YES), the concentration of the purge gas is started to be measured with the control valve 26 closed (step S52, timings t20 to t21). The measurement of the concentration of the purge gas with the control valve 26 closed can be performed by the aforementioned method. A gas concentration C15 upon when the concentration of the purge gas stabilized is stored in the ECU 100 as the gas concentration history, and a gas concentration storing history is set to an ON state (step S53, timing t21).

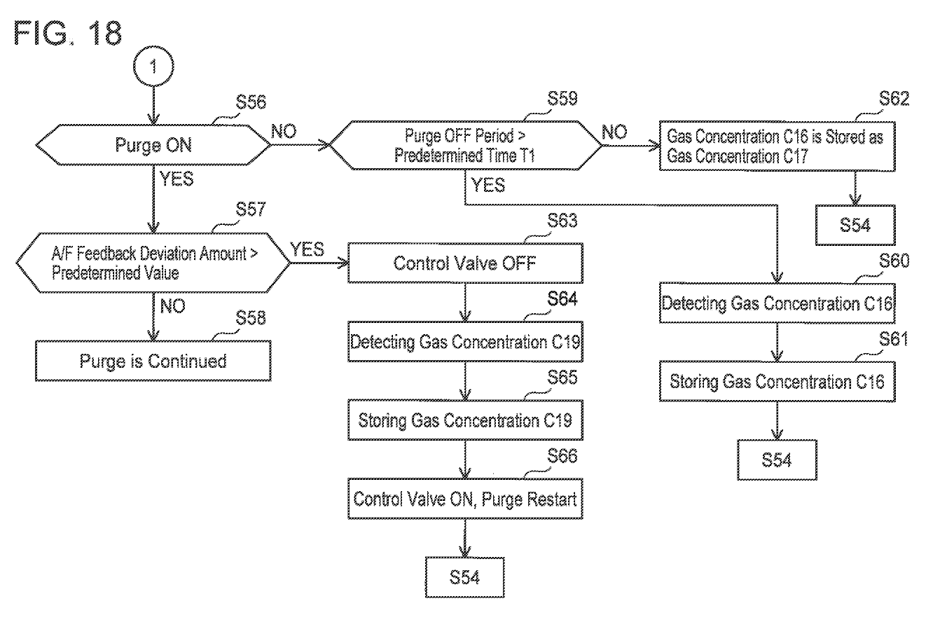

After the gas concentration storing history has been set to the ON state, the control valve 26 is turned on and a purge is started (step S54, timing t22). Upon when the purge is started, the aperture (or the duty ratio) of the control valve 26 and the flow rate (the output) of the pump 52 are determined based on the gas concentration C15, In a case where the gas concentration of the purge gas is stored in the ECU 100 (step S51: NO), the purge is started based on the stored gas concentration. That is, in the case where the gas concentration is not stored (the gas concentration storing history is OFF), the gas concentration is measured without starting a purge (the first purge after the engine has been activated), and then the purge is started, During the purge, whether the engine water temperature is less than a second predetermined value (e.g., 60° C.) (step S55: YES) or the engine water temperature is equal to or greater than the second predetermined value (step S55: NO) is measured. In this method, a method of correcting the purge gas concentration differs depending on whether the engine water temperature is less than the second predetermined value or not. In the case where the engine water temperature is less than the second predetermined value, the process proceeds to a process of step S56 in FIG. 18, In a case where the purge is set to the on-state (the control valve 26 is in the on-state) in step S56 (step S56: YES) and in a case where a feedback deviation from an A/F sensor is equal to or less than a predetermined value Al (step S57: NO), the purge is continued (step S58). A case where the feedback deviation from the A/F sensor is greater than the predetermined value A1 (step S57: YES) will be described later. The feedback deviation from the A/F sensor may be used to correct the purge gas concentration stored in the ECU 100 based on the feedback deviation without stopping the purge (while continuing the purge). By correcting the gas concentration, the supply quantity of the purge gas can more accurately be adjusted.

In a case where the purge is set to the off-state in step S56 (timing t23, step S56: NO), the process proceeds to step S59 and it is determined whether or not a purge-off period (a period between timings t23 and t24) is longer than a predetermined time period T1. In a case where the period between t23 and t24 is longer than the predetermined time period T1 (step S59: YES), the concentration of the purge gas is measured with the purge in the off-state (step S60), A gas concentration C16 upon when the concentration of the purge gas stabilized is stored in the ECU 100 (step S61), the process returns to step S54 of FIG. 17 at the timing t24 when the next purge is started, the aperture of the control valve 26 and the flow rate of the pump 52 are controlled based on the concentration C16, and the purge is continued.

In a case where the purge-off period is shorter than the predetermined time period T1 in step S59, such as a period between t25 and t26 (step S59: NO), the concentration of the purge gas cannot be detected while the purge is in the off state. In this case, the gas concentration C16 stared in the ECU 100 when the purge was set to the off-state (at the timing t25) (gas concentration that was measured when the purge was previously set to the off-state) is stored as a gas concentration C17 to be used at a timing of the next purge (at the timing t26) (step S62), After this, the process returns to step S54 of FIG. 17, the aperture (duty ratio) of the control valve 26 and the flow rate of the pump 52 are controlled based on the gas concentration C17 (the gas concentration C16), and the purge is continued.

Here, the case where the feedback deviation from the A/F sensor is greater than the predetermined value A1 in step S57 of FIG. 18 (step S57: YES) will be described with reference to FIG. 21. In this case, even when the purge is in the on-state (timings t22 to t23), the control valve 26 is turned off for a predetermined time period (step S63, timing t22a) and a purge gas concentration C19 is measured (step S64). That is, the purge is substantially set to the off-state. The purge gas concentration C19 upon when the concentration of the purge gas stabilized is stored in the ECU 100 (step S65), and then the purge is restarted (the control valve is turned on) (step S66, timing t22b). The process returns to step S54 of FIG. 17 at the timing t22b, the aperture of the control valve 26 and the flow rate of the pump 52 are controlled based on the gas concentration C19, and the purge is continued.

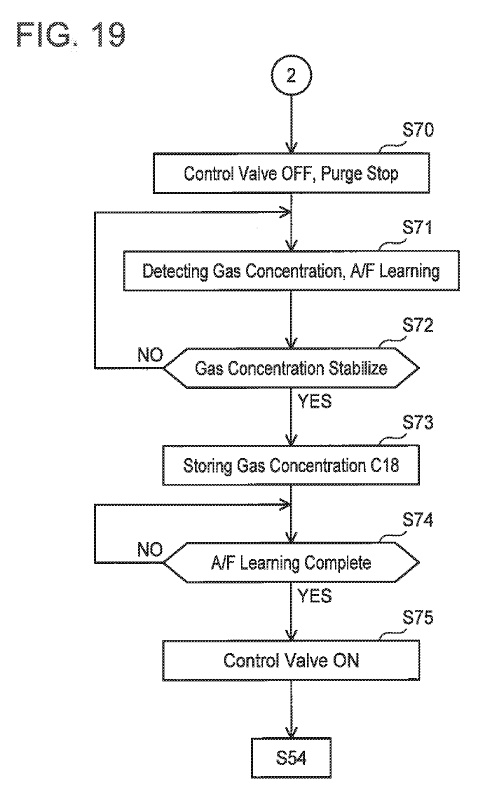

Next, a case where the engine water temperature in FIG. 17 is equal to or greater than the second predetermined value (step S55: NO) will be described with reference to FIGS. 19 and 20. Typically, in the vehicle, an A/F learning is started when the engine water temperature becomes equal to or greater than the second predetermined value (e.g., 60′C). When the engine water temperature becomes equal to or greater than the second predetermined value (step S55: NO), the control valve 26 is turned off and the purge is stopped (step S70, timing t27). The measurement of the purge gas concentration and the A/F learning are started under the state in which the purge is stopped (step S71). In a case where the purge gas concentration is not stabilized (step S72: NO), the detection is continued until the purge gas concentration stabilizes. After the purge gas concentration has been stabilized (step S72: YES), a detected gas concentration C18 is stored in the ECU 100 (step S73). After this, it is determined whether or not the A/F learning is completed (step S74). In a case where the A/F learning is completed (step S74: YES), the control valve 26 is turned on (step S75, timing t28), the aperture (duty ratio) of the control valve 26 and the flow rate of the pump 52 are controlled based on a concentration that is obtained by correcting the gas concentration C18 by au A/F feedback, and the purge is continued.

While specific examples of the present invention have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present invention is not limited to the combinations described at the time the claims are filed. Further, the purpose of the examples illustrated by the present description or drawings is to satisfy multiple objectives simultaneously, and satisfying any one of those objectives gives technical utility to the present invention.

1. An evaporated fuel processing device comprising:
a canister configured to adsorb fuel evaporated in a fuel tank;
a purge passage that is connected between the canister and an intake passage of an engine, and through which a purge gas sent from the canister to the engine passes;
a pump provided on the purge passage;
a concentration sensor configured to detect a concentration of the purge gas;
a branch passage having both ends thereof connected to the purge passage, and provided with the concentration sensor;
a switching device configured to switch between a purge passage passing state and a purge passage non-passing state, the purge passage passing state being a state in which the purge gas flows to the intake passage by passing through the purge passage between the both ends of the branch passage, and the purge passage non-passing state being a state in which the purge gas flows to the intake passage without passing through the purge passage between the both ends of the branch passage; and
a control valve provided on the purge passage between the intake passage and the pump, and configured to switch between a communication state and a cutoff state, the communication state being a state in which the purge passage and the intake passage communicate with each other, and the cutoff state being a state in which communication between the purge passage and the intake passage is cut off.

2. The evaporated fuel processing device according to claim 1, wherein
airflow resistance of the purge passage is smaller than airflow resistance of the branch passage.

3. The evaporated fuel processing device according to claim 2, wherein
the switching device is configured to cut off flow of the purge gas to the branch passage in the purge passage passing state.

4. The evaporated fuel processing device according to claim 3, further comprising a controller configured to control the pump, the switching device, and the control valve.

5. The evaporated fuel processing device according to claim 4, wherein
after a startup operation of a vehicle is performed, the controller is configured to set the switching device to the purge passage non-passing state, set the control valve to the communication state, and perform control of scavenging the branch passage and detecting the concentration of the purge gas.

6. The evaporated fuel processing device according to claim 5, wherein
when the detecting of the concentration of the purge gas has been performed after the startup operation of the vehicle, and purging based on the detected concentration has been performed and stopped, the controller is configured to set the switching device to the purge passage non-passing state, set the control valve to the communication state, and performs control of detecting the concentration of the purge gas.

7. The evaporated fuel processing device according to claim 6, wherein
when the detecting of the concentration of the purge gas has been performed after the startup operation of the vehicle, purging based on the detected concentration has been performed and stopped, and the purging is performed again, the controller is configured to set the switching device to the purge passage non-passing state, set the control valve to the communication state, and perform control of detecting the concentration of the purge gas.

8. The evaporated fuel processing device according to claim 7, wherein the controller is configured to perform control of driving the pump when the switching device is in the purge passage non-passing state.

9. The evaporated fuel processing device according to claim 8, further comprising a second switching device provided on the purge passage, the second switching device configured to switch between a first state in which the purge passage communicates with the canister and a second state in which the purge passage communicates with open air.

10. The evaporated fuel processing device according to claim 1, wherein
the switching device is configured to cut off flow of the purge gas to the branch passage in the purge passage passing state.

11. The evaporated fuel processing device according to claim 1, further comprising a controller configured to control the pump, the switching device, and the control valve.

12. The evaporated fuel processing device according to claim 11, wherein
after a startup operation of a vehicle is performed, the controller is configured to set the switching device to the purge passage non-passing state, set the control valve to the communication state, and perform control of scavenging the branch passage and detecting the concentration of the purge gas.

13. The evaporated fuel processing device according to claim 12, wherein
when the detecting of the concentration of the purge gas has been performed after the startup operation of the vehicle, and purging based on the detected concentration has been performed and stopped, the controller is configured to set the switching device to the purge passage non-passing state, set the control valve to the communication state, and performs control of detecting the concentration of the purge gas.

14. The evaporated fuel processing device according to claim 12, wherein
when the detecting of the concentration of the purge gas has been performed after the startup operation of the vehicle, purging based on the detected concentration has been performed and stopped, and the purging is performed again, the controller is configured to set the switching device to the purge passage non-passing state, set the control valve to the communication state, and perform control of detecting the concentration of the purge gas.

15. The evaporated fuel processing device according to claim 11 wherein the controller is configured to perform control of driving the pump when the switching device is in the purge passage non-passing state.

16. The evaporated fuel processing device according to claim 11, further comprising a second switching device provided on the purge passage, the second switching device configured to switch between a first state in which the purge passage communicates with the canister and a second state in which the purge passage communicates with open air.
